(19) United States
(12) Patent Application Publication
(10) Pub. No.: US 2015/0077317 A1
(43) Pub. Date: Mar. 19, 2015

(54) MATRIX SUBSTRATE AND DISPLAY DEVICE

(71) Applicant: Sharp Kabushiki Kaisha, Osaka-shi, Osaka (JP)

(72) Inventors: Masakazu Miyamoto, Osaka-shi (JP); Toshiaki Fujihara, Osaka-shi (JP); Kazuhiro Yoshikawa, Osaka-shi (JP); Yoshihiro Asai, Osaka-shi (JP)

(21) Appl. No.: 14/390,077

(22) PCT Filed: Apr. 18, 2013
(86) PCT No.: PCT/JP2013/061474

§ 371 Date: Oct. 2, 2014

(30) Foreign Application Priority Data
Apr. 25, 2012 (JP) 2012-099794

(51) Int. Cl. G09G 3/36

(52) U.S. Cl. CPC G09G 3/3611
USPC 345/87

(57) ABSTRACT

A matrix substrate includes: a pixel region (A); a first line (G) that is connected to the pixels arrayed in one direction in the pixel region (A); a second line (S) that is connected to the pixels arrayed in a direction different from the one direction; a terminal region (17a) in which a terminal for inputting a signal is arranged; and a left lead line (kS3, kS4) that goes around the left side of the pixel region (A) from a side of the pixel region (A) where the terminal region (17a) is provided and is led out to the opposite side, and a right lead line (kS1, kS2) that goes around the right side and is led out to the opposite side. The left lead line and the right lead line are connected to the first line (G) or the second line (S) via a collective region (D).

### TECHNICAL FIELD

The present invention relates to a technology for a matrix substrate having a pixel region in which a plurality of pixels are arrange in a matrix.

### BACKGROUND ART

Recently, flat panel display devices including, e.g., liquid crystal display devices have been used widely as display portions of electrical products such as a computer and a television.

Such display devices generally include a display region formed by arranging a plurality of pixels in a matrix, and a plurality of lines for transmitting signals to the pixels. The plurality of lines are formed in the display region in the substrate, led to the outside of the display region, and connected to input terminals. The input terminals are often arranged on one side surface side of the substrate. In some cases, lead lines for connecting the input terminals and the plurality of lines in the display region are arranged so as to go around the left and right of the display region from the one side surface side and be connected to the lines in the display region from a side opposite the side where the input terminals are arranged (e.g., see Patent Documents 1-3)

### PRIOR ART DOCUMENTS

### Patent Documents

Patent Document 1: JP 2011-158707 A

Patent Document 2: JP 2007-25700 A

Patent Document 3: JP 2007-183527 A

### DISCLOSURE OF INVENTION

### Problem to be Solved by the Invention

As in the above conventional technology, in the case where the lead lines are arranged to go around the left and right of the display region from the terminals located on one side of the display region and be connected to the lines in the display region on the opposite side of the display region, streak unevenness extending in the direction of the plurality of lines may occur when signals are input to the plurality of lines in the display region via the lead lines.

It was found that this phenomenon is largely due to a difference in length, especially at end portions of the display region, between the lead lines going around the left of the display region from the terminals and the lead lines going around the right of the display region from the terminals. In other words, especially at the end portions of the display region, a delay of a signal to be input to the right lead lines extending the right side of the display region is different from a delay of a signal to be input to the left lead lines extending the left side of the display region. Because of this, when the lines of the display region connected to the right lead lines and the lines of the display region connected to the left lead lines are adjacent to each other, voltages to be supplied to respective pixels by passing these adjacent lines will be different between the lines. Consequently, streak unevenness along the lines occurs.

With the foregoing in mind, it is an object of the present invention to provide a matrix substrate or a display device having a configuration capable of suppressing occurrence of unevenness even when arranging lead lines to go around the left and right of the display region from the terminal region.

### Means for Solving Problem

A matrix substrate in one embodiment of the present invention includes: a pixel region in which a plurality of pixels are arrange in a matrix; a first line that is connected to the pixels arrayed in one direction in the pixel region; a second line that is connected to the pixels arrayed in a direction different from the one direction; a terminal region in which a terminal for inputting a signal to the first line or the second line is arranged and that is located outside the pixel region; and a lead line that goes around the pixel region from one side surface side of the pixel region where the terminal region is provided and is led out to an opposite side of the pixel region, and connected to the first line or the second line from the opposite side. The lead line includes a left lead line that goes around the left side of the pixel region from the one side surface side and is led out to the opposite side, and a right lead line that goes around the right side of the pixel region from the one side surface side and is led out to the opposite side. The left lead line and the right lead line are led out to a predetermined collective region on the opposite side and connected to the first line or the second line via the collective region.

In the above configuration, both of the left lead line and the right lead line pass the collective region and then are connected to the lines of the pixel region. Because of this, a difference in path length will not be large between a left path, going around the left of the pixel region from the terminal on the one side surface side where the terminal region is provided and reaching the lines of the display region via the collective region, and a right path, going around the right side of the pixel region from the terminal on the one side surface side and reaching the lines of the display region via the collective region. As a result, a difference in signal delay based on a difference in line resistance between the left lead line and the right lead line also can be suppressed. Consequently, occurrence of unevenness can be suppressed even when applying a voltage to the lines via the left lead line and the right lead line.

In the above embodiment, the collective region may be arranged on the opposite side of the pixel region so that a distance from a right end of the pixel region to the collective region is substantially equal to a distance from a left end of the pixel region to the collective region.

Thereby, it is possible to further reduce the difference in path length between the path going around the left of the pixel region from the terminal region and reaching the lines of the display region and the path going around the right and reaching the lines of the pixel region.

In the above embodiment, the collective region may be arranged so that a length of the left lead line from the one side surface side to the collective region is substantially equal to a length of the right lead line from the one side surface side to the collective region. Thereby, it is possible to further suppress a difference in signal delay based on a difference in line resistance between the left lead line and the right lead line.

Incidentally, the aforementioned case in which the distances from the collective region to the left and right ends of the pixel region are equal to each other, or the case in which the distances of the left and right lead lines are equal to each other includes not only a case in which these distances exactly coincide with each other, but also a case in which these distances can be considered as equal. For example, the following cases can be considered as equal distance: even if there is a difference between these distances, it can be judged to be within tolerance; a difference in signal delay due to the difference in distance is not so large as to affect display images, and the like.

A matrix substrate in another embodiment of the present invention includes: a pixel region in which a plurality of pixels are arrange in a matrix; a first line that is connected to the pixels arrayed in one direction in the pixel region; a second line that is connected to the pixels arrayed in a direction different from the one direction; a terminal region in which a terminal for inputting a signal to the first line or the second line is arranged and that is located outside the pixel region; a terminal-side lead line that is led out from the one side surface side of the pixel region where the terminal region is provided and connected to the first line or the second line from the one side surface side of the pixel region; and a side lead line that is led out from the one side surface side and connected to the first line or the second line from the left or right side of the pixel region. At least one of the terminal-side lead line and the side lead line includes a plurality of lines and, in at least part of the plurality of lines, two lines adjacent to each other are formed in different layers with an insulating film interposed therebetween.

In an area where a plurality of the lead lines are concentrated, e.g., in the vicinity of the terminal region, the interval of the adjacent lead lines becomes narrow, which sometimes makes it difficult to arrange a plurality of lead lines. By forming the two adjacent lines in different layers with an insulating film interposed therebetween as in the above configuration, it becomes possible to arrange a plurality of lead lines densely.

In the above embodiment, the matrix substrate may have the following aspect: the matrix substrate includes a lead line that goes around the pixel region from the one side surface side to the opposite side and is connected to the first line or the second line from the opposite side. The lead line includes a left lead line that goes around the left side of the pixel region and is led out to the opposite side, and a right lead line that goes around the right side of the pixel region and is led out to the opposite side. At least one of the left lead line, the right lead line, the terminal-side lead line, and the side lead line includes a plurality of lines and, in at least part of the plurality of lines, two lines adjacent to each other are formed in different layers with an insulating film interposed therebetween.

In the above embodiment, the matrix substrate may have the following aspect: the terminal-side lead line and the side lead line each include a plurality of lines and, in at least part of the plurality of lines, two lines adjacent to each other are formed in different layers with an insulating film interposed therebetween.

In the above embodiment, the matrix substrate may have the following aspect: the terminal region is located outside an opposed region where a counter substrate is opposed to the matrix substrate, and in the opposed region, of the two adjacent lines formed in the different layers, a line formed in one of the layers is shifted to the other layer and then led to the outside of the opposed region.

With the above configuration, the two adjacent lines are formed in the same layer in the opposed region where the counter substrate is provided, and then are led out from the inside to the outside of the opposed region. These lines are susceptible to external influences outside the opposed region. However, by the above configuration, the lines are shifted to a layer where influences upon lines are lesser, and then led to the outside of the opposed region.

In the above embodiment, the matrix substrate may have the following aspect: the two adjacent lines formed in the different layers are formed at a position not overlapping with each other in a thickness direction of the layers. Thereby, it is possible to reduce influences of the two adjacent lines working upon each other.

A display device that includes the above matrix substrate is included in an embodiment of the present invention. Further, a liquid crystal display device that includes the above matrix substrate and a counter substrate that is opposed to the matrix substrate with a liquid crystal layer interposed therebetween also is an embodiment of the present invention.

### Effects of the Invention

According to embodiments of the present invention, in the matrix substrate, it is possible to suppress occurrence of unevenness even in the case of arranging lead lines to go around the left and right of the pixel region from the terminal region.

### BRIEF DESCRIPTION OF DRAWINGS

FIG. 1 is a diagram showing a configuration example of a liquid crystal display device according to first embodiment of the present invention.

FIG. 2 is a diagram illustrating a configuration example of a circuit for driving each of pixels of a liquid crystal panel.

FIG. 3 is a diagram showing a configuration example of wiring on an active matrix substrate.

FIG. 4 is a diagram showing an arrangement example in which lead lines that go around the left and right of a display region are connected to data lines without passing a collective region.

FIG. 5 is a diagram showing a wiring example of a matrix substrate in second embodiment.

FIG. 6 is a diagram showing a wiring example of a matrix substrate in third embodiment.

FIG. 7 is a diagram showing a wiring example of a matrix substrate in fourth embodiment.

FIG. 8 is a diagram showing a configuration example of a plurality of lines formed in different layers seen from a thickness direction of the layers.

FIGS. 9A to 9C are cross-sectional views taken along a line X-X in FIG. 8.

FIG. 10 is a diagram showing a modified example of a configuration of a connection shifting portion seen from a thickness direction of the layers.

FIG. 11 is a cross-sectional view taken along a line XI-XI in FIG. 10.

### DESCRIPTION OF THE INVENTION

Hereinafter, preferred embodiments of a display device of the present invention will be described with reference to the drawings. In the following description, the present invention is applied to a transmission type liquid crystal display device. The size and size ratio of each of the constituent members in the drawings do not faithfully reflect those of the actual constituent members.

### First Embodiment

(Configuration Example of Liquid Crystal Display Device)

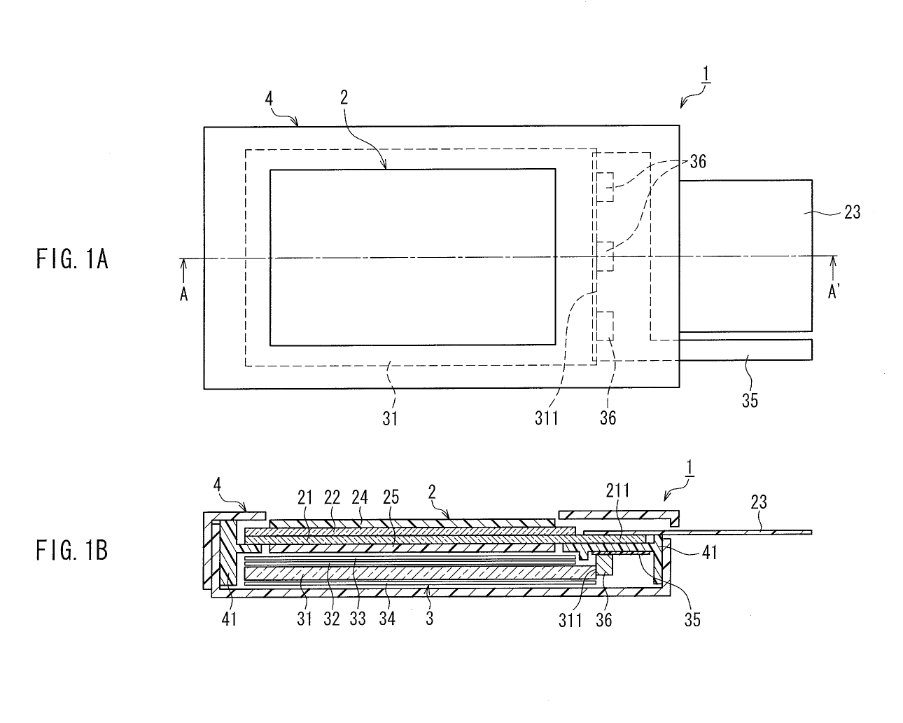

FIG. 1 is a diagram illustrating a liquid crystal display device according to first embodiment of the present invention. FIG. 1A is a front view of the liquid crystal display device, and FIG. 1B is a cross-sectional view of the liquid crystal display device taken along a line A-A′ shown in FIG. 1A. In FIGS. 1A and 1B, a liquid crystal display device 1 includes a liquid crystal panel 2 as a display portion for displaying information, a backlight device 3 as a backlight portion, and a housing 4 for receiving the liquid crystal panel 2 and the backlight device 3. The housing 4 is formed from resin or a metallic frame, and receives the liquid crystal panel 2 and the backlight device 3 with a side wall 41 interposed therebetween. In the liquid crystal display device 1, the liquid crystal panel 2 uses illumination light from the backlight device 3 to display information. The liquid crystal panel 2 and the backlight device 3 are integrated into the transmission type liquid crystal display device 1.

The liquid crystal display device shown in FIG. 1 can be used to portable terminal devices such as a portable telephone, a smartphone, an electronic book, a portable game machine, and a PDA. Note that application of the display device of the present invention is not limited to portable terminal devices, and it can be applied widely to stationary display devices such as a television and electronic devices such as a facsimile and a digital camera.

The liquid crystal panel 2 includes a liquid crystal layer, and an active matrix substrate 21 (TFT array substrate) and a counter substrate 22 that are a pair of substrates sandwiching the liquid crystal layer. As will be described in detail later, pixel electrodes, thin film transistors (TFTs), or the like are formed between the active matrix substrate 21 and the liquid crystal layer so as to correspond to a plurality of pixels included in a display surface of the liquid crystal panel 2. On the other hand, color filters, a common electrode, or the like are formed between the counter substrate 22 and the liquid crystal layer (not shown). For example, an upper polarizer 24 and a lower polarizer 25 in a crossed nicol state are arranged on outer sides of the active matrix substrate 21 and the counter substrate 22, respectively. A ¼ λ, plate (quarter wavelength plate) may be arranged between the polarizer and the liquid crystal layer.

The active matrix substrate 21 has a frame-shaped portion 211 protruding from the counter substrate 22, i.e., a non-opposed region not covered with the counter substrate 22. A flexible printed circuit (FPC) board 23 is provided on the frame-shaped portion 211. The FPC board 23 is a board with flexibility that connects a driver (not shown) provided on the frame-shaped portion 211 and a control circuit or the like (not shown) for controlling the driver. The driver performs drive control of the liquid crystal panel 2 so that the liquid crystal layer is operated on a pixel-by-pixel basis, and thus the display surface is driven on a pixel-by-pixel basis, thereby displaying a desired image on the display surface.

The liquid crystal panel 2 of this embodiment may be, e.g., a normally black mode. Therefore, the liquid crystal panel 2 of this embodiment is configured so that when no voltage is applied to the liquid crystal layer, black display is performed, and the transmittance of light through the liquid crystal layer is increased with the voltage to be applied.

The backlight device 3 includes a light guide plate 31, a first prism sheet 32, a second prism sheet 33, a reflection plate 34, a FPC board 35, and LEDs 36.

The light guide plate 31 causes light from the LEDs 36 to be incident upon a light incident surface 311 provided on a side surface of the light guide plate 31, reflects the incident light in multiple directions at a light reflection surface of the light guide plate 31, and emits the reflected light from a light emission surface thereof to the liquid crystal panel 2 side as uniform light. The first prism sheet 32 and the second prism sheet 33 improve brightness of the light emitted from the light guide plate 31, and are provided on the upper surface of the light guide plate 31. The reflection plate 34 reflects the light from the LEDs 36 toward the liquid crystal panel 2 side, and is provided on the lower surface of the light guide plate 31. Although the light guide plate 31 has a uniform thickness in FIG. 1, the thickness may be reduced along the width direction from the light incident surface 311 side, or reversely be increased along the width direction from the light incident surface 311 side.

The LEDs 36 as light source components are arranged in line on an LED arrangement portion 351 of the FPC board 35 on the light incident surface 311 side. Electric power is supplied to the LEDs 36 via a line forming a power source line in the FPC board 35, thereby turning ON the LEDs 36. Although the LEDs 36 used herein are surface-mounted LEDs, they may be clipped LEDs.

Incidentally, the configuration of the liquid crystal display device is not limited to the above example. A silver or white coating with high light reflectance may be applied to the bottom of the housing 4 that faces the light guide plate 31 and the LEDs 36, and this bottom of the housing 4 may be used instead of the reflection plate 34 to reflect light from the LEDs 36 and the light guide plate 31. For convenience of explanation, FIG. 1 exemplary shows a case in which three LEDs 36 are arranged on the LED arrangement portion 351. However, one or a plurality of LEDs 36 may be arranged depending on the application purpose of the liquid crystal display device 1.

(Configuration Example of Circuit)

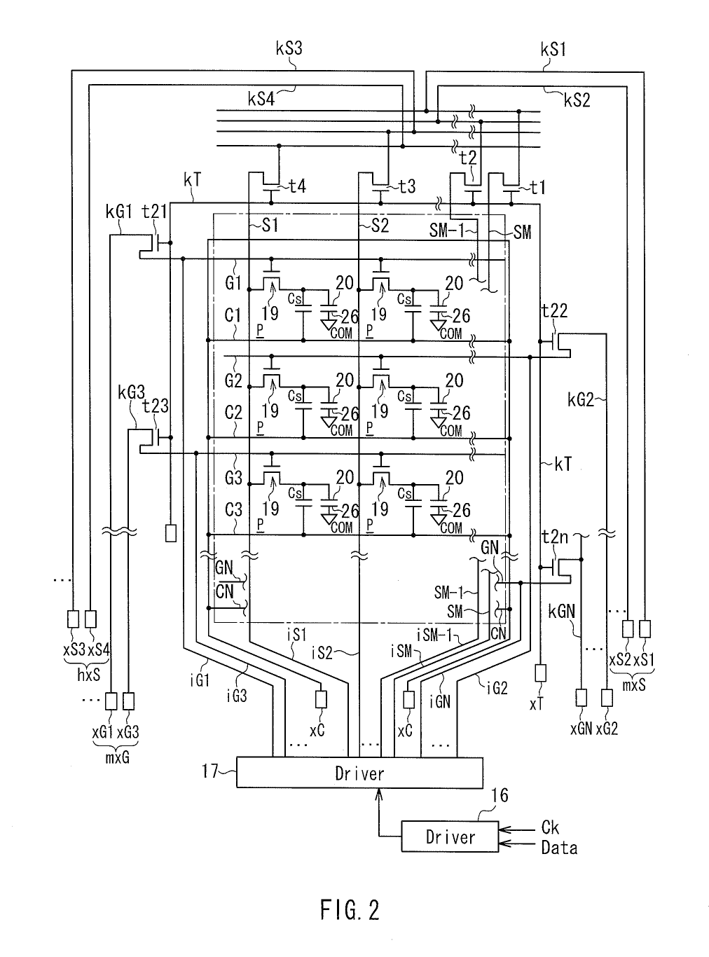

FIG. 2 is a diagram illustrating a configuration example of a circuit for driving each of pixels of the liquid crystal panel shown in FIG. 1.

In the example shown in FIG. 2, the liquid crystal panel 2 has gate lines G1 to GN (N is an integer of 2 or more, and the gate lines are generically called “G” in the following) and source lines S1 to SM (M is an integer of 2 or more, and the source lines are generically called “S” in the following) in a display region A (an example of a pixel region). The gate lines G and the source lines S extend along rows and columns of pixels P arranged in a matrix, respectively. The gate lines G and the source lines S are provided in two directions that intersect each other, and the pixels P are provided so as to correspond to each of the intersections of the gate lines G and the source lines S. In this embodiment, the gate lines G are arranged along the horizontal direction of the display screen, and the source lines S are arranged along the direction perpendicular to the gate lines G (i.e., the perpendicular direction). The gate lines G are an example of first lines that are connected to the pixels arrayed in one direction in the pixel region, and the source lines S are an example of second lines that are connected to the pixels arrayed in a direction different from the one direction. Further, in this example, auxiliary capacitance lines C1 to CN (N is an integer of 2 or more, and the auxiliary capacitance lines are generically called “C” in the following) are provided parallel to the gate lines G.

A driver 17 is an integral drive circuit in which a source driver and a gate driver are formed integrally. The driver 17 is a drive circuit for driving a plurality of the pixels P on the liquid crystal panel 2 on a pixel-by-pixel basis. A plurality of the source lines S and a plurality of the gate lines G are connected respectively to the driver 17. The pixels P are formed in the areas that are arranged in a matrix and separated from one another by the source lines S and the gate lines G. A plurality of the pixels P may include red, green, and blue pixels P. For example, three pixels arranged successively along the source line S may be red, green, and blue pixels, and these three pixels can serve as one pixel unit. In this case, the long side of a rectangular pixel electrode in one pixel is an extending direction of the source lines S (vertical stripe pixel).

Based on an instruction signal (gate signal G-Dr) from a control unit 16, the gate driver included in the driver 17 applies a gate voltage in sequence to the gate lines G so that gates of the corresponding switching elements 19 are turned ON. On the other hand, based on an instruction signal (source signal S-Dr) from the control unit 16, the source driver included in the driver 17 outputs a gradation signal (gradation voltage) in response to the brightness (gradation) of the display image to the corresponding source lines S. The gate lines G are an example of scanning lines, and the gate signal is an example of a scanning signal.

The pixels P are connected to the gate lines G and the source lines S. When the gate voltage is applied (i.e., the gate signal is input) to the gate lines G, a row of pixels connected to each of these gate lines are selected. Then, a source voltage (gradation voltage) is applied (i.e., the gradation signal is input) to the selected pixels via the source lines.

Specifically, the switching elements 19 are provided for each of the pixels P. The switching elements 19 can be composed of, e.g., thin film transistors (TFTs). The gates of the switching elements 19 are connected to the individual gate lines G. On the other hand, sources of the switching elements 19 are connected to the individual source lines S. Moreover, pixel electrodes 20, which are provided for each of the pixels P, are connected to drains of the switching elements 19. Each of the pixels P includes a common electrode 21 that is located opposite the pixel electrode 20 with the liquid crystal layer of the liquid crystal panel 2 interposed between them. Auxiliary capacitances Cs are connected between the drains of the switching elements 19 and the auxiliary capacitance lines C. A common voltage V_TFTCOM is applied to the auxiliary capacitance lines C.

In this configuration, when the gate voltage is high (when the switching elements 19 are n-channel TFTs), the gates of the switching elements 19 are turned ON, and then the source voltage is applied to the pixel electrodes 20 to change the voltages of the pixel electrodes 20, so that the liquid crystal capacitances, each of which is composed of the common electrode 21 and the pixel electrode 20 sandwiching the liquid crystal layer, are charged.

The control unit 16 includes a control circuit that controls the driver 17 based on a reference clock signal CK and a video signal Data that are input externally. Further, the control unit 16 preferably includes a frame memory that is capable of storing display data contained in the video signal on frame-by-frame basis. The control unit 16 can perform a predetermined operation at a high speed on the display data that is sequentially stored in the frame memory. The control unit 16 can be constituted, e.g., with one or more than one ASIC (application specific integrated circuit). The control unit 16 may be formed by either a plurality of chips or circuits, or a single integrated circuit.

In the example shown in FIG. 2, the source lines S1 to SM are led out from the display region by source lead lines iS1 to iSM, and connected to terminals of the driver 17. The gate lines G1 to GN are led out from the display region by gate lead lines iG1 to iGM, and connected to terminals of the driver 17. Among the gate lines G1 to GN, the gate lines G1, G3, . . . are led out from the left side of the display region, whereas the remaining gate lines G2, . . . GN are led out from the right side of the display region. In this example, a plurality of the gate lines G are arranged so that the gate lines G led out to the right side and the gate lines G led out to the left side are disposed alternately one by one.

Ends of the source lines S that are not connected to the driver 17 are connected respectively to lead lines kS1, kS2, kS3, kS4, . . . that are data inspection lines, via inspection transistors t1, t2, t3, t4, . . . that are an example of switching elements. The source lines S are led out by the lead lines kS1, kS2, kS3, kS4, . . . from the opposite side of a mounting region of the driver 17, and connected to terminals xS1, xS2, xS3, xS4, . . . that are input terminals for data inspection signal. The lead lines kS3, kS4, . . . serving as data inspection lines, which are connected to the source lines S1, S2, . . . among the source lines S1 to SM, go around the left side of the display region, and are led out to terminals xS3, xS4, . . . serving as left input terminals hxS for data inspection signal. The lead lines kS1, kS2, . . . serving as data inspection lines, which are connected to the remaining source lines SM, SM−1, . . . , go around the right side of the display region, and are led out to terminals xS1, xS2, . . . serving as right input terminals mxS for data inspection signal. The detailed example of the lead lines of the source lines will be described later.

The gate lines G are connected respectively to lead lines kG1, kG2, kG3, . . . kGN that are gate inspection lines, via inspection transistors t21, t22, t23, . . . t2n that are an example of switching elements, and then led out to terminals xG1, xG2, xG3, . . . xGN that are input terminals for gate inspection signal. The lead lines kG1, kG3, . . . serving as gate inspection lines, which are connected to the gate lines G1, G3, . . . among the gate lines G1 to GN, are led out from the left side of the display region to terminals xG1, xG3, . . . serving as left input terminals for gate inspection signal. The lead lines kG2, . . . kGN serving as gate inspection lines, which are connected to the remaining gate lines G2, . . . GN, are led out from the right side of the display region to terminals xG2, . . . xGN serving as right input terminals for gate inspection signal. In this example, a plurality of the gate lines G are connected alternately to the lead lines on the left side and the lead lines on the right side one by one. The inspection transistors t1 to t4, t21 to t2n can be formed using TFTs. Gates of the inspection transistors t1 to t4, t21 to t2n are connected to an inspection transistor control signal line kT. The inspection transistor control signal line kT is connected to a terminal xT that is an input terminal for inspection transistor control signal.

In the example shown in FIG. 2, lead lines are connected to both of one end and the other end of the source lines of the display region, and the source lines are led out to different terminals by the respective lead lines. The lead lines that are connected to the other ends of the source lines pass a peripheral part on the both sides of the display region and reach the terminals provided on the both sides. All of the lead lines on the both sides are arranged to pass a predetermined region (collective region). Thereby, it is possible to reduce a difference in distance from the respective terminals between the lead lines connected respectively to a plurality of the source lines arranged close to each other in the display region. The detailed example of these lead lines will be described later.

(Wiring Example of Matrix Substrate)

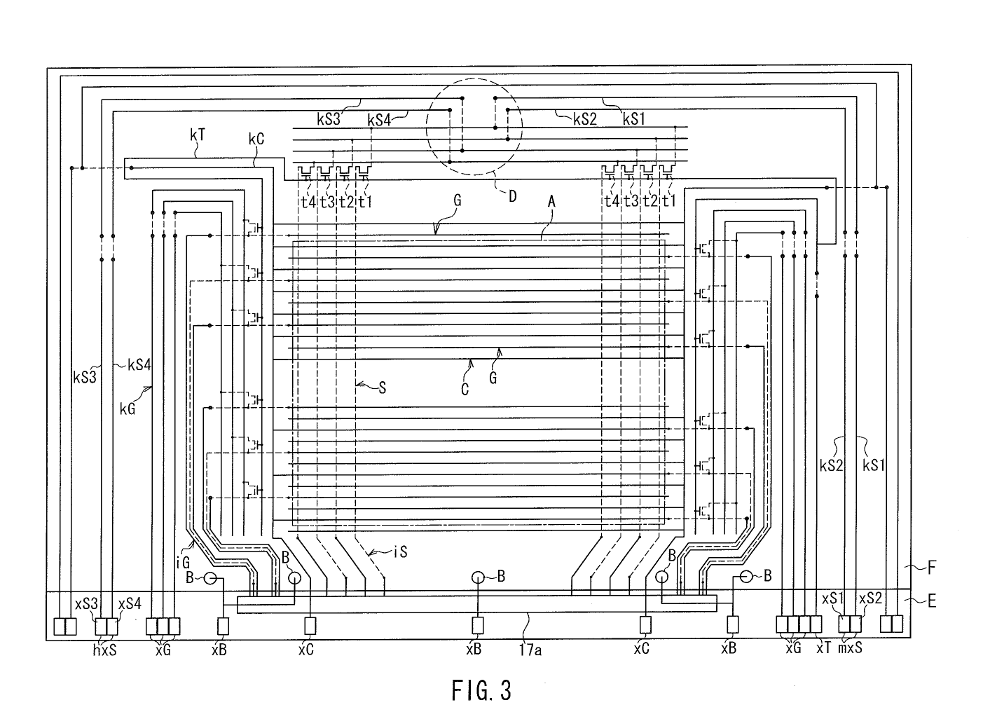

FIG. 3 is a diagram showing a configuration example of wiring on an active matrix substrate. As an example, FIG. 3 shows a wiring example in a case where the circuit configuration shown in FIG. 2 is formed on a matrix substrate. In the display region A, a plurality of the source lines S are formed in a source layer, and a plurality of the gate lines G are formed in a gate layer that is another layer located under the source layer with an insulating film interposed therebetween. The source lines S form data bus lines, and the gate lines G form gate bus lines. In FIG. 3, solid lines indicate lines of the gate layer, and broken lines indicate lines of the source layer. Filled circles indicate points where the gate layer and the source layer are connected. In this example, the gate lines G are formed in the gate layer, a gate insulating film (not shown) is provided so as to cover the gate lines G, and the source lines S are formed on the gate insulting film, i.e., formed in the source layer.

In the active matrix substrate, a portion covered with the counter substrate, i.e., an opposed region, includes the display region A, and a portion not covered with the counter substrate includes a driver mounting region 17a and input terminals for various signals. The driver mounting region 17a is a region where the driver 17 shown in FIG. 2 is mounted. A terminal region where terminals for inputting signals to the source lines or the gate lines are disposed can be arranged, e.g., in the driver mounting region 17a or the periphery thereof. Incidentally, it is unnecessary to directly mount drivers on the driver mounting region 17a. The FPC board equipped with a driver may be connected to the driver mounting region 17a.

with the counter substrate, i.e., an opposed region, includes the display region A, and a portion not covered with the counter substrate includes a driver mounting region 17a and input terminals for various signals. The driver mounting region 17a is a region where the driver 17 shown in FIG. 2 is mounted. A terminal region where terminals for inputting signals to the source lines or the gate lines are disposed can be arranged, e.g., in the driver mounting region 17a or the periphery thereof. Incidentally, it is unnecessary to directly mount drivers on the driver mounting region 17a. The FPC board equipped with a driver may be connected to the driver mounting region 17a.

The terminals for inputting signals to the lines in the display region A are located outside the display region A on at least one of side surfaces surrounding the display region A. In the example shown in FIG. 3, the terminal region is arranged on the side where the driver mounting region 17a is arranged. The respective lead lines that are connected with the terminals are connected to the lines in the display region A from one of sides of the display region A.

From the driver mounting region side of the display region A, the source lead lines iS1 to iSM are connected to the source lines S. A data signal (voltage) for driving the respective pixels is input (applied) to the source lines S via the source lead lines iS. The source lead lines iS are an example of terminal-side lead lines that are connected to the lines of the display region from one side surface side of the display region A where the terminal region is provided.

From the side of the source lines S opposite the side from which a driving signal is input (i.e., the opposite side of the one side surface side where the terminal region is provided), the lead lines kS1, kS2, kS3, kS4 for data inspection signal are connected. For example, a data inspection signal is input to the source lines via these lead lines.

In this example, the lead lines for data inspection signal include the first to fourth lead lines kS1, kS2, kS3, kS4. The first to fourth lead lines kS1, kS2, kS3, kS4 are connected successively to the four adjacent source lines S via the first to fourth inspection transistors t1, t2, t3, t4. Specifically, the first to fourth lead lines kS1 to kS4 are connected correspondingly to the first to fourth inspection transistors t1 to t4, which are connected correspondingly to the four source lines disposed successively. That is, each of the first to fourth lead lines is connected to one of the four adjacent source lines via the inspection transistor. Thereby, different signals can be input to the four adjacent source lines through the first to fourth lead lines.

Further, the gates of the inspection transistors t1 to t4 are connected to the inspection transistor control signal line kT. By the control signal input from the terminal xT to the control signal line kT, the transistors t1 to t4 are switched ON/OFF. Thereby, it is possible to control the input of the inspection signal.

All of the first to fourth lead lines kS1 to kS4 are arranged so as to pass a collective region D located near the center of the side of the display region A opposite the data signal input side, and connected to the respective source lines (data lines) S. Among the first to fourth lead lines kS1 to kS4, the first and second lead lines kS1, kS2 go around to the side of the display region A opposite the driver mounting region 17a side by passing the right side of the display region A from the right input terminal mxS for data inspection signal, and reach the source lines S via the collective region D. On the other hand, the third and fourth lead lines kS3, kS4 go around to the side of the display region A opposite the driver mounting region 17a side by passing the left side of the display region A from the left input terminal hxS for data inspection signal, and reach the source lines S via the collective region D. Thus, it is possible to obtain a wiring layout in which the lead lines passing different sides of the display region A each take a detour to extend to an inner direction of the display region.

The first and second lead lines kS1, kS2 are an example of right lead lines that go around the right side of the display region from the terminal region and are led out to the opposite side. The third and fourth lead lines kS3, kS4 are an example of left lead lines that go around the left side of the display region from the terminal region and are led out to the opposite side.

As a specific example, part of the first and second lead lines are arranged in a non-display region on the right side of the display region and on the opposite side of the signal input side of the source lines S. Part of the third and fourth lead lines are arranged in the non-display region on the left side of the display region and on the opposite side of the signal input side of the source lines S. Then, in the collective region D, the first and second lead lines kS1, kS2 and the third and fourth lead lines kS3, kS4 each have a portion turning back at 180 degrees. More specifically, in the non-display region on the side opposite the signal input side of the source lines S, the first to fourth lead line portions extending along the side of the display region A and covering an arrangement area of the source lines S are arranged. At a position near the center of these first to fourth lead line portions, the first and second lead line portions extending from the right side and the third and fourth lead lines extending from the left side are connected respectively to the source lines S.

By arranging the lead lines kS1 to kS4 in the above-described manner, at any part of the display region, a difference in distance from the respective signal input terminals between the lead lines corresponding to the adjacent data bus lines can be prevented from being large, whereby a difference in signal delay based on a difference in line resistance can be prevented from being large. In FIG. 3, in the four adjacent source lines S at the left end portion of the display region A for example, it is possible to obtain an effect that a difference between a distance from the right input terminal xS2 of the second lead line kS2 to the inspection transistor t2 and a distance from the left input terminal xS3 of the third lead line kS3 to the inspection transistor t3 is reduced. This effect is exhibited more significantly by minimizing a difference between a distance from the right terminal mxS to the collective region D and a distance from the left terminal hxS to the collective region D. By the above effect, a difference in signal delay is reduced between the source line that is connected to the inspection transistor t2 among the four adjacent source lines S at the left end portion and the source line next to said source line, i.e., the source line that is connected to the inspection transistor t3.

Thereby, for example, display unevenness with vertical streaks can be suppressed when inputting the inspection signal to the corresponding pixels via the lead lines. As a result, erroneous recognition in inspection of line leakage at high resistance, local thinning of lines, and the like are less likely to occur, which improves inspection accuracy. For example, there is a case in which a display image at the time of inputting the inspection signal to the source lines via the lead lines is inspected visually. In this case, if the streak unevenness along the source line occurring in a display image due to the difference in signal delay of the inspection signal is recognized visually, the unevenness may be misunderstood as one generated due to breakage or thinning of the source lines. According to this embodiment, it is possible to suppress occurrence of unevenness that causes such erroneous recognition.

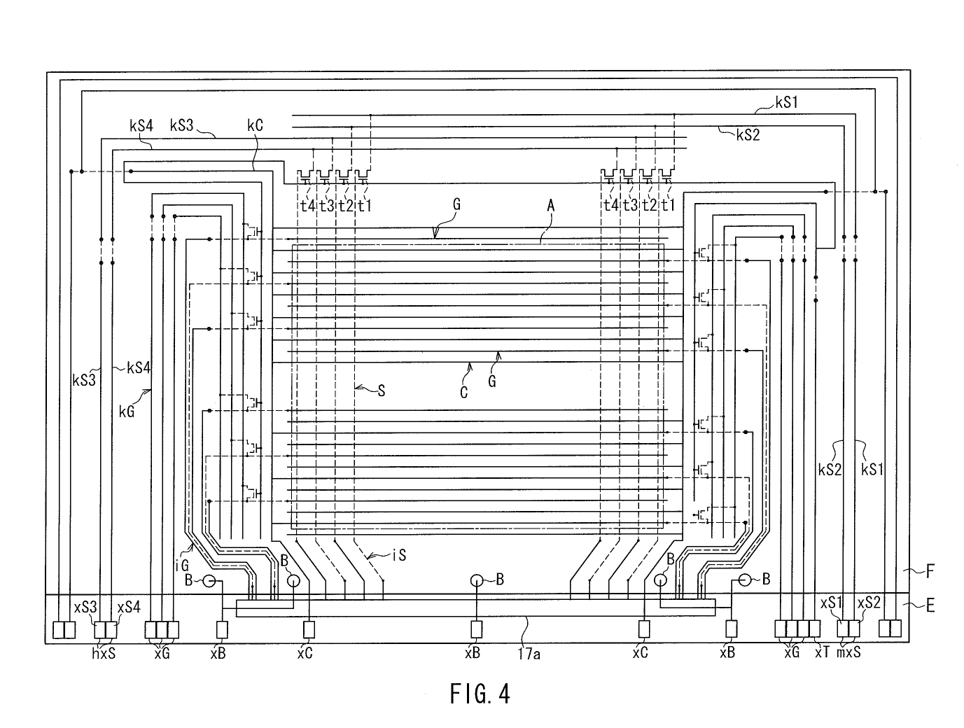

FIG. 4 is a diagram showing an arrangement example in which the lead lines that go around the left and right of the display region are connected to the source lines S without passing the collective region. In the example shown in FIG. 4, the third and fourth lead line portions arranged in the non-display region on the left side of the display region A from the left terminal hxS is connected directly to the lead line portions extending along the side of the display region A opposite the signal input side. Similarly, the first and second lead lines arranged in the non-display region on the right side of the display region A from the right terminal mxS is connected directly to the lead line portions extending along the side of the display region A opposite the signal input side. Because of this, the first to fourth lead lines kS1 to kS4 are connected respectively to data bus lines (source lines S) via the inspection transistors t1 to t4 without passing the collective region D.

In the case of the wiring shown in FIG. 4, a difference in distance between the first to fourth lead lines that are connected to the four adjacent source lines S will be larger than that shown in FIG. 3. In other words, a difference between a distance from the terminal mxS of the first and second lead lines kS1, kS2 to the inspection transistors t1, t2 and a distance from the terminal hxS of the third and fourth lead lines kS3, kS4 to the inspection transistors t3, t4 will be large.

In the arrangement example shown in FIG. 3, in terms of reducing the difference in length between the path of the first and second lead lines kS1, kS2 and the path of the third and fourth lead lines kS3, kS4, it is preferred that the collective region D is set near the center of the side of the display region A opposite the driver mounting side. Alternatively, it is preferred that the collective region D is set so that the distance from the right terminal mxS of the first and second lead lines kS1, kS2 to the transistors t1, t2 and the distance from the left terminal hxS of the third and fourth lead lines kS3, kS4 to the transistors t3, t4 are substantially equal to each other. The distance of these two lead lines being substantially equal to each other includes not only a case in which the distances exactly coincide with each other, but also a case in which the difference in distance is so small that an influence of signal delay due to the difference in distance to be exerted upon display quality is negligible.

(Example of Two-Layered Lead Lines)

In the examples shown in FIGS. 3 and 4, in the lead lines iS connecting the source lines S and the driver mounting region 17a, the adjacent lines are formed in different layers. Specifically, a plurality of the lead lines are arranged so that the lines formed in the source layer and the lines formed in the gate layer are arranged alternately. Thereby, it is possible to suppress an area occupied by the lead lines of the source lines S in the non-display region located outside the signal input side of the display region A. In the vicinity of a boundary with a non-opposed region E, the lines of the source layer are shifted from the source layer to the gate layer within an opposed region F, and extend from the opposed region F to the non-opposed region E in the gate layer. Thereby, all of the lead lines are formed in the gate layer in the boundary between the opposed region F and the non-opposed region E and the non-opposed region E.

Also in the lead lines iG connecting the gate lines G and the driver mounting region 17a, the adjacent lines are formed in different layers. The lead lines iG are an example of side lead lines that are led out from the terminal region and connected to the lines of the display region from the left or right side of the display region. Also in the non-display region on the left and right of the display region A, the lead lines iG are configured so that the adjacent lines are formed in different layers. Thereby, it is possible to suppress an area occupied by the lead lines of the gate lines G in the non-display region (frame-shaped region) located outside the left and right sides of the display region A. Further, in the vicinity of the boundary with the non-opposed region E, the lines formed in the source layer inside the opposed region F are shifted to the gate layer, and extend from the opposed region F to the non-opposed region E in the gate layer.

With the above configuration, of the two adjacent lines formed in the different layers in the opposed region F, the line formed in one of the layers is shifted to the other layer, and led to the outside of the opposed region. Thereby, in the boundary of the opposed region F and the outside, all of the lead lines can be formed in a single layer that is less susceptible to external influences. For example, when the source layer is not covered with a gate insulating film as in the above example, the number of protective insulating film layers of the source layer will be fewer than that of the gate layer. Because of this, a portion of the source layer not covered with the counter substrate is physically damaged easily. To cope with this, the lead lines that are arranged in the source layer in the portion covered with the counter substrate can be shifted to the gate layer before entering the portion not covered with the counter substrate. Thereby, it is possible to further protect the lead lines in the portion not covered with the counter substrate. Further, by providing a connection shifting portion from the source layer to the gate layer in the portion covered with the counter substrate, it also is possible to enhance the protection of the lead lines at the boundary between the portion covered with the counter substrate and the outside.

Incidentally, the configuration in which the adjacent lead lines are formed in a plurality of layers are not limited to the above example. For example, the lead lines may be formed in three or more separate layers. Alternatively, the adjacent lines may be formed in a plurality of layers in either of the lead lines iS of the source lines S and the lead lines iG of the gate lines G. Moreover, the adjacent lead lines may be formed in a plurality of different layers in the left source lead lines kS3, kS4, or in the gate lead line kG.

(Application Example of this Embodiment)

Next, specific examples in which this embodiment is applicable will be explained.

In the display device provided with a matrix substrate, horizontal stripe pixels are sometimes used so as to reduce the cost of drivers or mounting of drivers. The horizontal stripe pixels are pixels in which the long side of a rectangular pixel electrode is an extending direction of the gate bus line. By using the horizontal stripe pixels, as compared with the case of using vertical stripe pixels, the number of the gate bus lines (gate lines G) will be tripled, whereas the number of the data bus lines (source lines S) can be reduced to one third. Generally, the source driver to be connected to data bus lines is more expensive than the gate driver to be connected to gate bus lines. Therefore, in terms of production cost, it is advantageous to reduce the number of the source drivers to be used. Incidentally, the horizontal stripe pixels are wider than the vertical stripe pixels in the horizontal direction, and hence vertical streaks during inspection are more likely to be recognized.

As the number of the gate bus lines increases, the number of the lead lines increases accordingly. Because of this, in order to reduce the area occupied by the lead lines of the gate bus lines in the non-display region on the left and right sides of the display region A, it is preferable to form the lead lines in the gate layer and the source layer alternately as in the above example. When the lead lines are formed in the gate layer and the source layer alternately, in terms of protecting the lines in the portion not covered with the counter substrate, the lead lines arranged in the source layer can be shifted to the gate layer. It is preferable to form the connection shifting portion in the portion covered with the counter substrate, i.e., within the opposed region F.

When the connection shifting portion for shifting the lead lines of the gate bus lines from the source layer to the gate layer is formed in the opposed region F, the wiring region of the lead lines of the data bus lines (source lines S) will be narrow accordingly. To cope with this, the lead lines of the data bus lines also can be formed in the gate layer and the source layer alternately. Further, similarly to the lead lines of the gate bus lines, it is preferable to form the connection shifting portion within the opposed region F.

When the lead lines of the data bus lines are formed in the gate layer and the source layer alternately, it is preferable to also inspect the leakage of the adjacent lead lines in the same layer, in addition to the leakage of the adjacent data bus lines. For this purpose, it is possible to provide inspection signal lines to which different inspection signals can be input with respect to the four adjacent data bus lines. In the above example shown in FIG. 3, the first to fourth lead lines kS1 to kS4 are provided, thereby allowing signals to be input independently to the four adjacent data bus lines. In this example, the lead lines of the source lines S are set to be four channels.

On the data signal input side of the display region, it is difficult to secure an area for arranging inspection TFTs because the lead lines of the gate bus lines, the lead lines of the data bus lines, and common transitions are provided densely. For example, in the example shown in FIG. 3, common transitions B, which are portions for connection with the counter electrodes of the counter substrate, are arranged on the data signal input side of the display region A. Because of this, the inspection transistors t1 to t4 to be connected to the data bus lines are arranged on the opposite side of the data signal input side. At this time, for example, it is preferable to arrange two each of the lead lines for data inspection signal to take a detour on the left and right sides of the display region and then be connected to the inspection transistors via the collective region.

### Second Embodiment

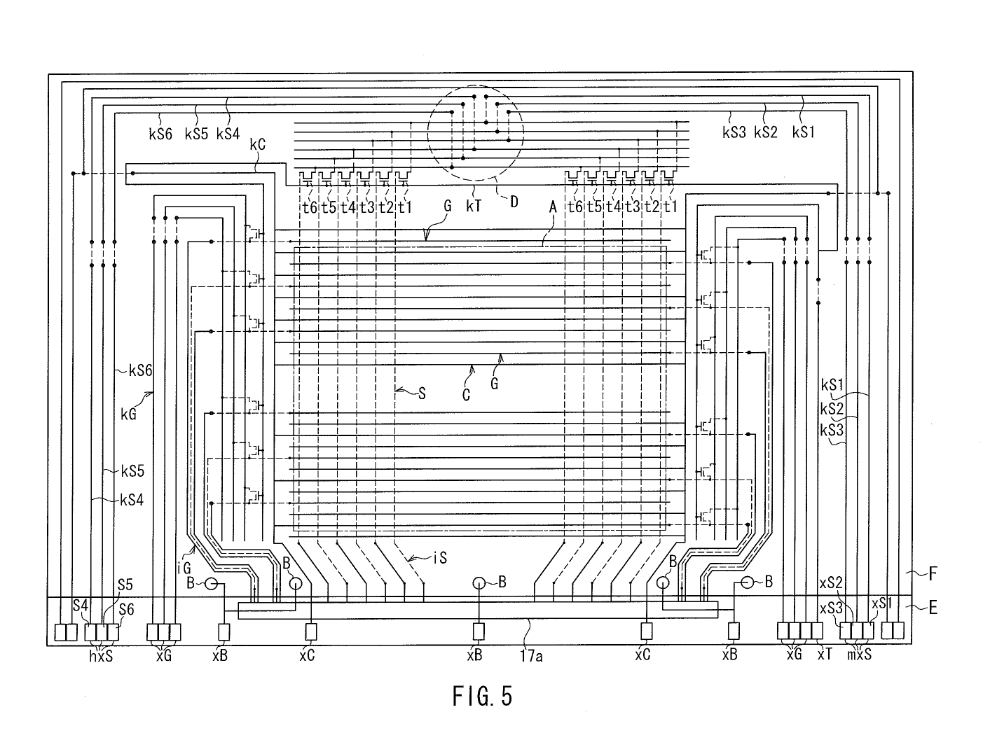

FIG. 5 is a diagram showing a wiring example of a matrix substrate in second embodiment. In the example shown in FIG. 5, the lead lines for inputting the inspection signal to the data bus lines are set to be six channels. Specifically, with respect to the side of the source lines S opposite the side from which the driving signal is input (i.e., the opposite side of the driver mounting region 17a), lead lines kS1, kS2, kS3, kS4, kS5, kS6 for data inspection signal are connected via transistors t1, t2, t3, t4, t5, t6. For example, the data inspection signal is input to the source lines via these lead lines.

In this example, the lead lines for data inspection signal include the first to sixth lead lines kS1 to kS6. The first to sixth lead lines kS1 to kS6 are connected successively to the six adjacent source lines S via the first to sixth inspection transistors t1 to t6. Specifically, the first to sixth lead lines kS1 to kS6 are connected correspondingly to the first to sixth inspection transistors t1 to t6, which are connected correspondingly to the six source lines disposed successively. That is, each of the first to sixth lead lines is connected to one of the six adjacent source lines via the transistor. Thereby, different signals can be input to the six adjacent source lines through the first to sixth lead lines.

All of the first to sixth lead lines kS1 to kS6 are arranged so as to pass the collective region D located near the center of the side of the display region A opposite the data signal input side, and connected to the respective source lines S. Among the first to sixth lead lines kS1 to kS6, the first to third lead lines kS1 to kS3 go around to the side of the display region A opposite the driver mounting region 17a side by passing the right side of the display region A from the right input terminal mxS for data inspection signal, and reach the source lines S via the collective region D. On the other hand, the fourth to sixth lead lines kS4 to kS6 go around to the side of the display region A opposite the driver mounting region 17a side by passing the left side of the display region A from the left input terminal hxS for data inspection signal, and reach the source lines S via the collective region D.

The first to third lead lines kS1 to kS3 are an example of right lead lines that go around the right side of the display region from the terminal region and are led out to the opposite side. The fourth to sixth lead lines kS4 to kS6 are an example of left lead lines that go around the left side of the display region from the terminal region and are led out to the opposite side.

Although the number of the lead lines of the data bus lines is four in first embodiment, it may be more than four. In this embodiment, the number of the lead lines of the data bus lines is six. Similarly, the number of the lead lines of the gate bus lines is not limited to the example shown in FIG. 3.

For example, this embodiment is applicable to vertical stripe pixels. In this case, via six lead line channels, a signal input corresponding to three colors of RGB becomes possible. Further, when adopting four colors (e.g., RGB+yellow), an inspection signal input corresponding to four colors becomes possible by providing eight lead lines for data inspection.

### Third Embodiment

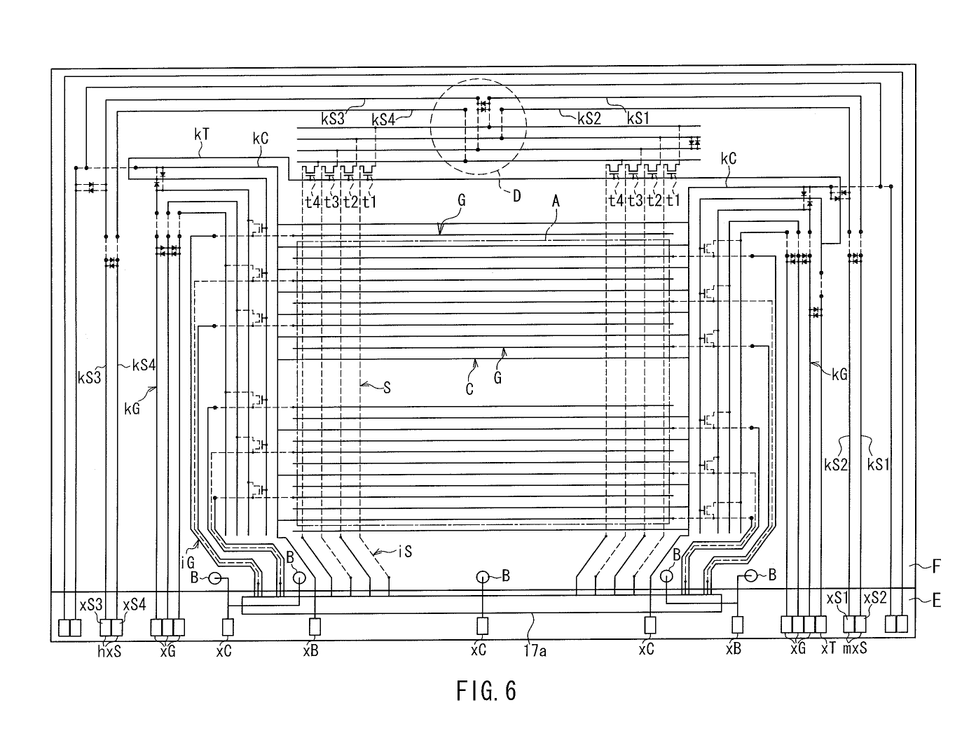

FIG. 6 is a diagram showing a wiring example of a matrix substrate in third embodiment. In the example shown in FIG. 6, there are provided connection elements for connection between a plurality of lead lines that are connected respectively to a plurality of the source lines, and connection elements for connection between the lead lines and the common electrode or auxiliary capacitance signal lines. The connection elements may be, e.g., ESD countermeasure elements provided as countermeasures against static electricity of the lead lines. As an example, back-to-back diodes can be used as the connection elements. Instead of the back-to-back diodes, e.g., transistors, semiconductor layers, or the like also can be used as the connection elements.

In this embodiment, a plurality of the lead lines connected to different lines are connected mutually, and connected also to the common electrode or auxiliary capacitance signal lines having a large capacity. By this configuration, it is possible to take countermeasures against static electricity of the lead lines. Incidentally, the effect achieved by the countermeasures against static electricity can be obtained singly by the connection between the lead lines, or the connection between the lead lines and the common electrode or auxiliary capacitance signal lines. When the lead lines of this embodiment are used as inspection lines, it is possible to reduce damage and failure of the inspection TFTs and of inspection lines due to static electricity during production process, which allows normal inspection. Further, it also is possible to reduce damage and failure of the display region due to static electricity.

In the example shown in FIG. 6, as a connection example between the lead lines in the collective region D, back-to-back diodes are used to connect the lead line kS3 of the data bus line connected to the left terminal hxS and the lead line kS1 of the data bus line connected to the right terminal mxS. Further, also in the right end portion of the lead line portion extending along the side of the display region A to which the lead lines are connected, the connection element is provided to connect the lead line kS3 and the lead line kS2. Moreover, the connection elements are provided for connection between the lead lines kS1, kS2 of the data bus lines on the right side of the display region A and between the lead lines kG of the gate bus lines, as well as between the lead lines kS3, kS4 of the data bus lines on the left side of the display region and between the lead lines kG of the gate bus lines.

As the connection example between the lead lines and the auxiliary capacitance signal lines or common electrode in FIG. 6, in the non-display region on both of the left and right sides of the display region A, the connection elements are provided between auxiliary capacitance signal lines kC and lead lines kG of the gate bus lines. Moreover, in the non-display region on the right side of the display region A, the lead line kS2 of the data bus line and the auxiliary capacitance signal line kC are connected. In the non-display region on the left side of the display region A, the lead line kS3 of the data bus line and the common electrode are connected.

### Fourth Embodiment

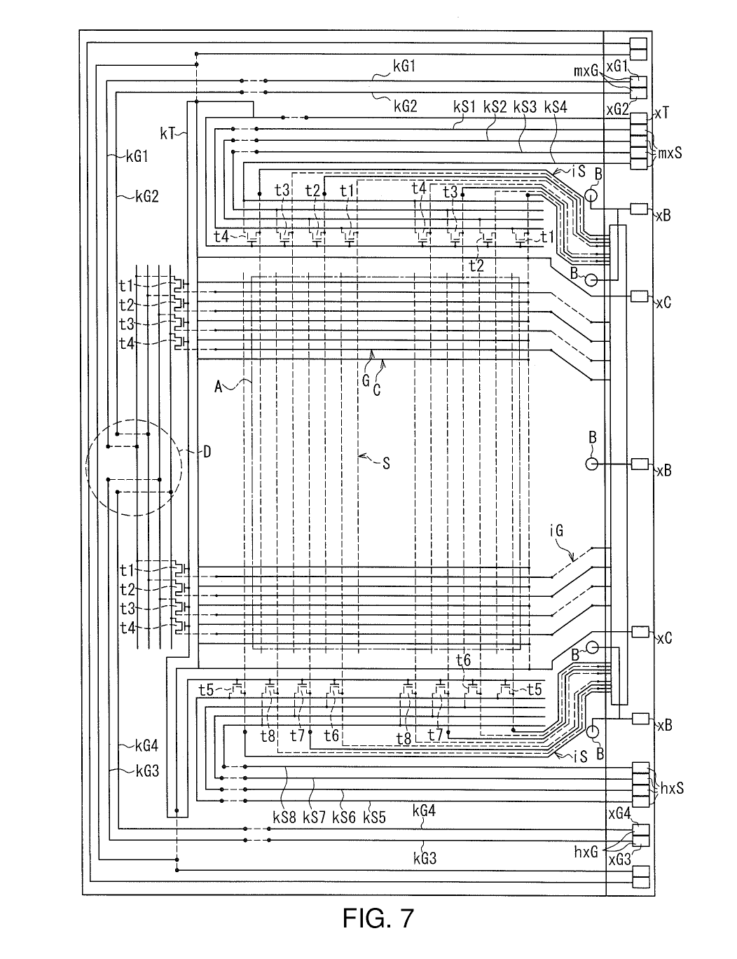

FIG. 7 is a diagram showing a wiring example of a matrix substrate in fourth embodiment. In the example shown in FIG. 7, the lead lines kG1, kG2, kG3, kG4 go around the left and right of the display region A from the terminals provided on one of two sides of the rectangular display region A that are parallel to the source lines, to the other side, and are connected to the gate lines from the other side.

In this example, the portion not covered with the counter substrate is provided on the one of two sides of the display region A that are parallel to the source lines. The driver mounting region 17a and the terminal region are provided also in the portion not covered with the counter substrate on the one side.

The gate lead lines iG are connected to the gate lines G from the driver mounting region side of the display region A. Via the gate lead lines iG, a control signal (or also referred to as a gate signal) is input to the gate lines G that are connected to gate electrodes of the TFTs 19. The TFTs 19 are switching elements of the respective pixels. All the gate lead lines iG for inputting the control signal to the gate lines G are connected to the gate lines G from the driver mounting region side of the display region A. On the other hand, the source lead lines iS for inputting the data signal for driving the respective pixels go around the left and right of the display region A from the driver mounting region 17a, and are connected to the source lines S from the left and right sides of the display region A. A plurality of the source lines S are arranged so that the source lines led out from the right side and the source lines led out from the left side are disposed alternately one by one.

The source lines S are connected to lead lines kS1 to kS8 serving as data inspection lines via transistors t1 to t8, and led out to the terminals xS serving as input terminals of data inspection signal. The source lines S1, S3, . . . among the source lines S1 to SM are led out from one side of the display region A (a side on the left side seen from the driver mounting region 17a) to the terminal hxS serving as a left input terminal for data inspection signal. The remaining S2, S4, . . . are led out from another side of the display region (a side on the right side) to the terminal mxS serving as a right input terminal for data inspection signal. The first to fourth transistors t1 to t4 are connected to the corresponding four adjacent lines among the source lines that are led out to the one side. The first to fourth data lead lines kS1 to kS4 are connected to the corresponding first and the fourth transistors t1 to t4. Similarly, the fifth to eighth transistors t5 to t8 are connected to the corresponding four adjacent lines among the source lines that are led out to the another side on the opposite side. The fifth to eighth data lead lines kS5 to kS8 are connected to the corresponding fifth to eighth transistors t5 to t8.

From the side of the gate lines G opposite the side from which the control signal is input (i.e., the opposite side of the driver mounting region 17a), the lead lines kG1, kG2, kG3, kG4 for gate inspection signal are connected. For example, the gate inspection signal is input to the gate lines G via these lead lines.

In this example, the lead lines for gate inspection signal include the first to fourth lead lines kG1, kG2, kG3, kG4. The first to fourth lead lines kG1, kG2, kG3, kG4 are connected successively to the four adjacent gate lines G via the first to fourth transistors t1, t2, t3, t4. Specifically, the first to fourth lead lines kG1 to kG4 are connected correspondingly to the first to fourth transistors t1 to t4, which are connected correspondingly to the four gate lines disposed successively. That is, each of the first to fourth lead lines is connected to one of the four adjacent gate lines via the transistor. Thereby, different signals can be input to the four adjacent gate lines through the first to fourth lead lines.

The gates of the transistors t1 to t8 are connected to the transistor control signal line kT. The transistor control signal line kT is connected to the terminal xT serving as an input terminal for transistor control signal.

All of the first to fourth lead lines kG1 to kG4 are arranged so as to pass a collective region D located near the center of the side of the display region A opposite the control signal input side, and connected to the respective gate lines G. Among the first to fourth lead lines kG1 to kG4, the first and second lead lines kG1, kG2 go around to the side of the display region A opposite the driver mounting region 17a side by passing the right side of the display region A from the right input terminal mxG for gate inspection signal, and reach the gate lines G via the collective region D. On the other hand, the third and fourth lead lines kG3, kG4 go around to the side of the display region A opposite the driver mounting region 17a side by passing the left side of the display region A from the left input terminal hxG for gate inspection signal, and reach the gate lines G via the collective region D.

By arranging the lead lines kG1 to kG4 in the above-described manner, at any part of the display region, a difference in distance from the respective signal input terminals between the lead lines corresponding to the adjacent gate bus lines can be prevented from being large, whereby a difference in signal delay based on a difference in line resistance can be prevented from being large. In FIG. 7, in the four adjacent gate lines S at the left end (lowest portion) of the display region A for example, a difference is reduced between a distance from the right input terminal xG2 of the second lead line kG2 to the transistor t2 and a distance from the left input terminal xG3 of the third lead line kG3 to the transistor t3 (next to the transistor t2). Accordingly, a difference in signal delay is reduced between the gate line connected to the transistor t2 among the four adjacent gate lines G at the left end and the gate line next to this gate line, i.e., the gate line connected to the transistor t3. Consequently, it is possible to suppress occurrence of streak unevenness along the gate lines in a display image.

In the example shown in FIG. 7, the first to fourth transistors t1 to t4 according to first embodiment are applied to the gate lines. The first and second lead lines kG1, kG2 are an example of right lead lines that go around the right side of the display region from one side surface side where the terminal region is provided and are led out to the opposite side. The third and fourth lead lines kG3, kG4 are an example of left lead lines that go around the left side of the display region from one side surface side where the terminal region is provided and are led out to the opposite side. Further, in FIG. 7, the driver 17 is mounted on the signal input side of the gate bus lines. Such a configuration can be used suitably for the purpose of narrowing both of the upper and lower sides of the frame of the panel, for example.

Incidentally, this fourth embodiment can be combined with the connection elements described in the above third embodiment. This fourth embodiment also can be combined with the above second embodiment so that the lead lines for gate bus line inspection are set to be six channels.

### Fifth Embodiment

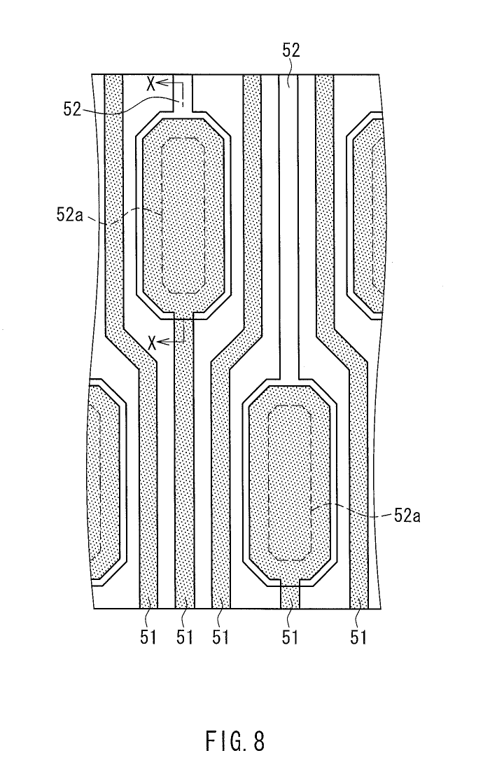

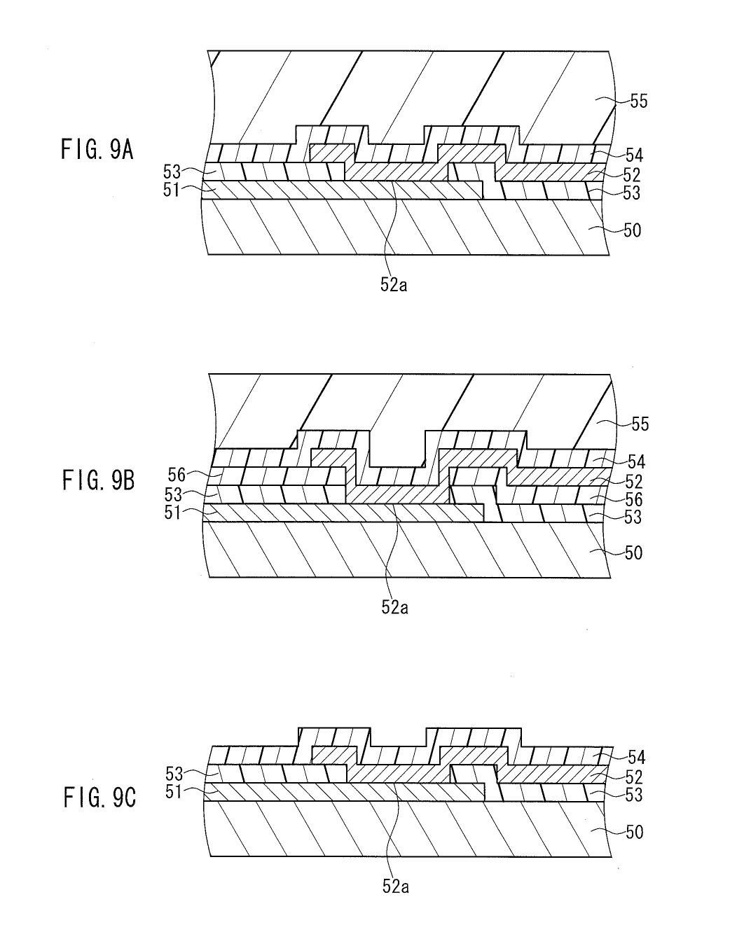

This embodiment is a detailed example of a connection shifting structure of the lead lines formed in different layers in the above first to fourth embodiments. The connection shifting structure of this embodiment is applicable to at least one of the configurations of the above first to fourth embodiments. FIG. 8 is a diagram showing a configuration example of a plurality of lines formed in different layers seen from the thickness direction of the layers. FIG. 9A to 9C are cross-sectional views taken along a line X-X in FIG. 8.

FIG. 8 shows a configuration example in the vicinity of the connection shifting portion where the connection is shifted between a gate metal 51 formed in the gate layer on the substrate and a source metal 52 formed on a gate insulting film that covers the gate metal 51, i.e., the source metal 52 is formed in the source layer. In the connection shifting portion, the gate metal 51 and the source metal 52 are formed so as to overlap with each other in the thickness direction of the layers. The gate insulating film is removed partially in the overlapped region, so that the source metal 52 contacts with the gate metal 51. In a contact portion 52a where the source metal 52 contacts with the gate metal 51, the line formed by the source metal 52 in the source layer is shifted to the gate metal 51 of the gate layer.

In the connection shifting portion, the source metal 52 and the gate metal 51 have a line width wider than those in the other portions. Thereby, the occurrence of malfunction such as a contact failure in the connection shifting portion can be suppressed. In correspondence to the wide portions of the source metal 52 and the gate metal 51 in the connection shifting portion, two adjacent gate metals 51 located on the left and right of the wide portions are arranged so as to have a wide interval therebetween. Thus, by widening the interval of the adjacent lines on the both sides of the wide portions depending on the line widths of the lines of the connection shifting portion, the lines can be arranged efficiently even in a region where a plurality of line are concentrated.

Further, in the example shown in FIG. 8, a line portion of the source metal 52 extending from the connection shifting portion, i.e., the portion of the source metal 52 having a narrower line width than the connection shifting portion, is formed at a position not overlapping, in the thickness direction of the layers, the line portion of the gate metal 51 located adjacent to the source metal 52 via a layer. In other words, the lines in the gate layer and the lines in the source layer extend parallel to each other without overlapping with each other. Thereby, it is possible to reduce the degree of interference between the adjacent lines extending parallel to each other.

FIG. 9A is a diagram showing an example of a cross section taken along the line X-X in FIG. 8. In FIG. 9A, the gate metal 51 is formed on a substrate 50, and a gate insulating film 53 is formed further on the substrate 50 so as to cover the gate metal 51. The source metal 52 is formed on the gate insulating film 53. In the overlapped portion of the gate metal 51 and the source metal 52, the contact portion 52a is formed where the gate metal 51 contacts with the source metal 52 without interposing the gate insulating film 53. On the gate insulating film 53 and the source metal 52, an inorganic insulating film 54 is formed further so as to cover them. On the inorganic insulating film 54, an organic insulating film 55 is formed further.

FIG. 9B is a diagram showing another example of a cross section taken along the line X-X in FIG. 8. In the example shown in FIG. 9B, a second inorganic insulating film 56 is stacked on the gate insulating film 53. The second inorganic insulating film 56 is, e.g., a protection insulating film that is arranged on a channel region of the TFTs of the display portion.

FIG. 9C is a diagram showing still another example of a cross section taken along the line X-X in FIG. 8. In the example shown in FIG. 9C, the organic insulating film 55 is not formed as compared with the configuration shown in FIG. 9A. In other words, the gate metal 51, the gate insulating film 53, the source metal 52, and the inorganic insulating film 54 are stacked on the substrate 50 in this order.

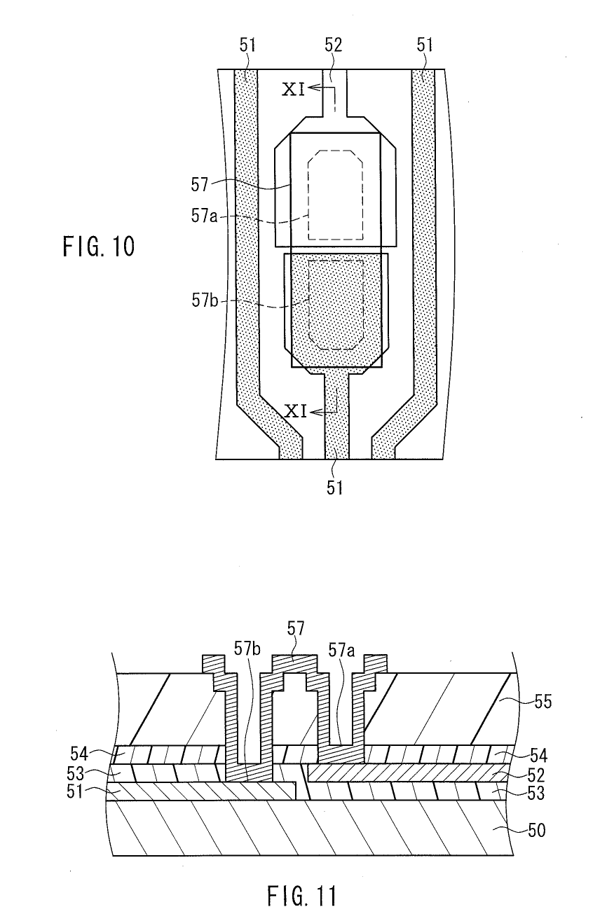

FIG. 10 is a diagram showing a modified example of the configuration of the connection shifting portion seen from the thickness direction of the layers. FIG. 11 is a cross-sectional view taken along a line XI-XI in FIG. 10. In the example shown in FIGS. 10 and 11, in the connection shifting portion from the source metal 52 to the gate metal 51, an end portion of the source metal 52 and an end portion of the gate metal 51 are located close to each other, at a position facing each other with the gate insulating film 53 interposed therebetween.

In the connection shifting portion, the gate metal 51 is connected to a pixel electrode layer 57, which is provided on the organic insulating film 55 through the gate insulating film 53, the inorganic insulating film 54 and the organic insulating film 55. In other words, in the connection shifting portion, a contact portion 57b is provided where the gate metal 51 contacts with the pixel electrode layer 57.

Further, on the gate insulating film 53, the source metal 52 extending close to the gate metal 51 is connected to the pixel electrode layer 57, which is provided on the organic insulating film 55 through the inorganic insulating film 54 and the organic insulating film 55 in the connection shifting portion. In other words, in the connection shifting portion, the contact portion 57a is provided where the source metal 52 contacts with the pixel electrode layer 57.

The contact portion 57a contacting with the source metal 52 and the contact portion 57b contacting with the gate metal 51 are connected to each other, thereby forming the pixel electrode layer 57. Thus, the source metal 52 and the gate metal 51 are connected electrically to each other. In the example shown in FIGS. 10 and 11, via a conducting film of the pixel electrode layer, the lines in the two different layers located under the conducting film are connected. Thus, it is unnecessary to include a step of patterning the gate insulating film so as to bring the source metal and the gate metal into direct contact with each other. In other words, an effect can be obtained that can shorten the production steps of the active matrix substrate. Incidentally, also in the example shown in FIGS. 10 and 11, in the connection shifting portion, the source metal 52 and the gate metal 51 have a line width wider than those in the other portions.

The configuration of the connection shifting portion of this embodiment can be used for connecting the lines in the source layer and the lines in the gate layer shown in FIGS. 3 to 7, for example. Especially, in the vicinity of the boundary of the opposed region F on the driver mounting region 17a side in FIGS. 3-7, in the portion where the lead lines are shifted from the source layer to the gate layer in the opposed region, the above configuration example can be used suitably. Note that the configuration of the connection shifting portion is not limited to the above examples.

### Modified Example of Embodiments

In the above embodiments, as an example, the display device is a liquid crystal display device. However, the display device to which the present invention is applicable is not limited to the liquid crystal display device. The present invention is applicable to any display devices that include a display region having a plurality of pixels and lines that transmit signals for driving the pixels. For example, the present invention is applicable to display devices such as an organic EL display, a microcapsule type electrophoretic display device, etc. The microcapsule type electrophoretic display device can display images by applying a voltage on a pixel-by-pixel basis to a microcapsule layer formed in the display region, for example. The display device may include lines of the display region that are connected via switching elements to pixel electrodes provided on a pixel-by-pixel basis, and a substrate with lead lines that are connected to lines of the display region, for example. This substrate can be configured as the active matrix substrates in the above embodiments, for example.

Further, the active matrix substrate to which the present invention is applicable is a substrate for an image sensor such as an X-ray sensor, for example. The X-ray sensing device can be configured by forming a charge conversion layer (e.g., a stacking structure of an antimony trisulfide layer and a selenium layer) on the pixel electrodes of the active matrix substrate, for example.

Moreover, the matrix substrate to which the present invention is applicable is not limited to the active matrix substrate. The present invention is also applicable to a passive-type matrix substrate, for example.

In the above embodiments, one end and the other end of the source lines or data lines of the display region are connected respectively to the input terminals for driving signal and the input terminals for inspection signal. However, the signal to be input to the other end is not limited to the inspection signal. In other words, the inspection transistors, the inspection lead lines, and the inspection signal input terminals in the above embodiments can be used for application purposes other than the transmission of the inspection signal. For example, when optical sensors are provided in the respective pixels, an output signal of the optical sensors can be output from the other end.

Further, the lead lines can be used to remove (discharge) charged electricity in the respective pixels after production of the display device, for example. Thereby, it is possible to suppress a change in operation characteristics of the switching elements such as TFTs.

Although in the above embodiment, the driver formed as an integrated member of the source driver and the gate driver is provided on one side of the display region, the configuration and the installation position of the driver are not limited to the above examples. For example, the source driver and the gate driver can be formed separately, and disposed separately in different sides of the display region. For example, the terminal region of the data signal where the terminals for inputting the data signal to the source lines are provided and the terminal region of the control signal where the terminals for inputting the control signal to the gate lines are provided may be disposed separately in two different sides of the display region. In this case, the lead lines can be formed so as to go around the left and right of the display region from at lease one of the terminal region of the control signal and the terminal region of the data signal to the opposite side and then to be connected to the source lines or the gate lines.

Moreover, although in the above explanation, the thin film transistors are used as switching elements, the switching elements of the present invention are not limited to these, and field-effect transistors can be used, for example.

### INDUSTRIAL APPLICABILITY

The present invention is useful as a matrix substrate or a display device that has a plurality of pixels and lines for driving the pixels.

### DESCRIPTION OF REFERENCE NUMERALS

1 liquid crystal display device
17a driver mounting region 17a (an example of a terminal region)
A display region
G gate lines (an example of first lines)
S source lines (an example of second lines)
kS1 to kS6 lead lines
kG1 to kG4 lead lines
iG, iS lead lines

1. A matrix substrate, comprising:
a pixel region in which a plurality of pixels are arrange in a matrix;
a first line that is connected to the pixels arrayed in one direction in the pixel region;
a second line that is connected to the pixels arrayed in a direction different from the one direction;
a terminal region in which a terminal for inputting a signal to the first line or the second line is arranged and that is located outside the pixel region; and
a lead line that goes around the pixel region from one side surface side of the pixel region where the terminal region is provided and is led out to an opposite side of the pixel region, and connected to the first line or the second line from the opposite side,
wherein the lead line includes a left lead line that goes around the left side of the pixel region from the one side surface side and is led out to the opposite side, and a right lead line that goes around the right side of the pixel region from the one side surface side and is led out to the opposite side, and
the left lead line and the right lead line are led out to a predetermined collective region on the opposite side and connected to the first line or the second line via the collective region.

2. The matrix substrate according to claim 1, wherein the collective region is arranged on the opposite side of the pixel region so that a distance from a right end of the pixel region to the collective region is substantially equal to a distance from a left end of the pixel region to the collective region.

3. The matrix substrate according to claim 1, wherein the collective region is arranged so that a length of the left lead line from the one side surface side to the collective region is substantially equal to a length of the right lead line from the one side surface side to the collective region.

4. The matrix substrate according to claim 1, further comprising:
a terminal-side lead line that is led out from the one side surface side and connected to the first line or the second line from the one side surface side of the pixel region; and
a side lead line that is led out from the one side surface side and connected to the first line or the second line from the left or right side of the pixel region,
wherein at least one of the left lead line, the right lead line, the terminal-side lead line, and the side lead line includes a plurality of lines and, in at least part of the plurality of lines, two lines adjacent to each other are formed in different layers with an insulating film interposed therebetween.

5. The matrix substrate according to claim 4, wherein the terminal-side lead line and the side lead line each include a plurality of lines and, in at least part of the plurality of lines, two lines adjacent to each other are formed in different layers with an insulating film interposed therebetween.

6. The matrix substrate according to claim 4, wherein the terminal region is located outside an opposed region where a counter substrate is opposed to the matrix substrate, and
in the opposed region, of the two adjacent lines formed in the different layers, a line formed in one of the layers is shifted to the other layer and led to the outside of the opposed region.

7. The matrix substrate according to claim 4, wherein the two adjacent lines formed in the different layers are formed at a position not overlapping with each other in a thickness direction of the layers.

8. The matrix substrate according to claim 1, wherein the left lead line and the right lead line each include at least two channels.

9. A display device comprising the matrix substrate according to claim 1.

10. A liquid crystal display device, comprising:
the matrix substrate according to claim 1; and
a counter substrate that is opposed to the matrix substrate with a liquid crystal layer interposed therebetween.
